(19) United States
(12) Patent Application Publication
(10) Pub. No.: US 2007/0119301 A1
(43) Pub. Date: May 31, 2007

(54) Humidity conditioner and humidity conditioning method using the same

(76) Inventor: Fujio Abe, Kyoto (JP)

Correspondence Address: WENDEROTH, LIND & PONACK, L.L.P., 2033 K STREET N. W., SUITE 800, WASHINGTON, DC, 20006-1021, US

(21) Appl. No.: 10/590,714

(22) PCT Filed: Feb. 25, 2005
(86) PCT No.: PCT/JP05/03673

§ 371 Date: Aug. 25, 2006

(30) Foreign Application Priority Data
Feb. 27, 2004 (JP) 2004-053856

(51) Int. Cl. B01D 53/02; C01B 31/16

(52) U.S. Cl. 95/117; 96/147; 252/184

(57) ABSTRACT

The present invention is a humidity conditioner having a configuration in which one or more water-soluble polymers are introduced into a three-dimensional framework that is formed by one or more crosslinked water-absorbing polymers. Here, for the water-absorbing polymers, either polyacrylate salt or one or more polyacrylate salt-polyvinyl alcohol copolymers can be used. For the water-soluble polymers, one or both of polyvinyl alcohol and polyisopropylacrylamide can be used.

### TECHNICAL FIELD

The present invention relates to a humidity conditioner having reversible functions of water absorption and discharge, and a humidity conditioning method using the humidity conditioner.

### BACKGROUND ART

In general, ones widely known as humidity conditioners are drying agents (absorbent materials) and moisturizing materials applying the chemical characteristics.

Absorbent materials are often produced by using inorganic substances, as typified by a silica gel and a zeolite, or using charcoal. These materials are put in containers, and used in order to stably store, for example, processed foods, magnetic tapes, and wooden building materials in a low humidity atmosphere. Furthermore, in recent years, absorbent materials applying water-absorbing polymers have continued to gain in popularity as absorbent materials used for paper diapers and menstrual sanitary products.

On the other hand, as to moisturizing materials, glycerin aqueous solutions and the like are used as water retention substances, and they are gelated and packed for use to stably store, for example, perishable foods as maintaining moistness of the foods in an adequately moisturized atmosphere.

Patent Reference 1: Japanese Laid-Open Patent Application No. 2002-292771

Patent Reference 2: Japanese Laid-Open Patent Application No. 2000-176022

### DISCLOSURE OF THE INVENTION

### What the Invention Aims to Resolve

A majority of humidity conditioners such as the absorbent materials and moisturizing materials described above have an irreversible chemical characteristic of being incapable of restoring the original state after being used. In particular, absorbent materials have several constraints of use because of this irreversible characteristic. Herewith, the above absorbent materials need to be replaced with new ones after a certain period of use, which incurs a cost in each time.

In addition, in the case of coming into contact with a relatively large amount of water by, for example, being directly covered with droplets of water, conventional absorbent materials have a characteristic of quickly losing moisture absorption effects. Accordingly, there is a demand for improving these absorbents so as to be capable of responding to changes in the environment to some degree.

With respect to these problems, a technology has been developed in which humidity of the ambient atmosphere is reversibly adjusted through moisture absorption and retention in a mechanical fashion (refer to Japanese Laid-Open Patent Application No. 2000-346537 and No. 2000-274924). Realistically speaking, however, using this technology in place of the above humidity conditioners leads to a drastic increase in the cost. Besides, there are restrictions regarding space and/or weight, and it is thus difficult to implement the technology.

The present invention has been made in view of the above problems, and has aimed at offering, at a relatively low cost, a humidity conditioner which realizes adequate humidity conditioning by exercising excellent water absorption and discharge functions and is still reusable after use. Also, the present invention has aimed at providing a humidity conditioning method using the humidity conditioner.

### Means to Resolve the Problems and Advantageous Effects of the Invention

In order to resolve the above problems, the present invention is a humidity conditioner having a configuration in which one or more water-soluble polymers are introduced into a three-dimensional framework that is formed by one or more crosslinked water-absorbing polymers.

Specifically speaking, the water-absorbing polymers may include either polyacrylate salt or one or more polyacrylate salt-polyvinyl alcohol copolymers.

The water-soluble polymers are composed of one or both of polyvinyl alcohol and polyisopropylacrylamide.

Furthermore, the present invention is a humidity conditioning method using a humidity conditioner that has a configuration in which polyvinyl alcohol is introduced into a three-dimensional framework composed of one or more water-absorbing polymers. The humidity conditioning method comprises the following steps: having the humidity conditioner absorb water; and adjusting a water discharge with an osmotic pressure gradient established by adding a sodium chloride solution having a concentration of no less than 0.01 M but no more than 3 M to the water-absorbed humidity conditioner.

Also, the present invention is a humidity conditioning method using a humidity conditioner that has a configuration in which one or more water-soluble polymers composed of polyvinyl alcohol are introduced into a three-dimensional framework composed of one or more water-absorbing polymers. The humidity conditioning method comprises the following steps: having the humidity conditioning absorb water; and adjusting a water discharge by causing the water-soluble polymers to swell with the water entered into the framework to thereby discharge the absorbed water to an outside of the framework.

Also the present invention is a humidity conditioning method using a humidity conditioner that has a configuration in which one or more water-soluble polymers composed of polyisopropylacrylamide is introduced into a three-dimensional framework composed of one ore more water-absorbing polymers. The humidity conditioning method comprises the following steps: having the humidity conditioner absorb water; and adjusting a water discharge by dehydrating the polyisopropylacrylamide through a heat treatment.

As described above, the humidity conditioner of the present invention has a configuration in which the water-soluble polymers are introduced into a three-dimensional framework composed of the water-absorbing polymers, such as sodium polyacrylate. Herewith, when water is absorbed, the water taken into the framework comes in contact with the water-soluble polymers present in the framework. The water-soluble polymers subsequently swell, and thereby the water is divided into small water masses or taken in inside the water-soluble polymers so as to form a hydrated gel.

Here, in the case when the small water masses described above are formed at the water absorption, the size of the water masses is reduced as compared in the case of a conventional absorbent material which is composed of water-absorbing polymers with no water-soluble polymers included. The size reduction leads to a decrease in surface tension. Since water evaporates less when the surface tension is larger, the small water masses tend to evaporate between cubic frames in the framework. In addition, due to the size reduction, the water masses are facilitated to move over to the outside from the space between the cubic frames of the framework, and the water masses are effectively discharged outside of the framework owing to pressure received as a result of the swelling of the water-soluble polymers. On such fundamental principles, the humidity conditioner of the present invention exhibits a water discharge function. Polyvinyl alcohol is one of such water-soluble polymers having the above water discharge function.

In the case when the water-soluble polymers are turned into a hydrated gel at the water absorption, it is possible to accelerate the water discharge by conducting a heat treatment on the water-soluble polymers to discharge the water to the outside of the framework. Chemically themosensitive water-soluble polymers have such an effect, and one example of these is polyisopropylacrylamide.

Thus, the present invention realizes reversible functions of water absorption and discharge by using the water-absorbing polymers as the humidity conditioner and establishing a configuration in which the water-soluble polymers (polyvinyl alcohol or polyisopropylacrylamide) are introduced into cavities present in the three-dimensional framework composed of the molecules of the water-absorbing polymers. Since the humidity conditioner is capable of adequately conditioning humidity by functioning as an absorbent material when in a dry state while functioning as a moisturizing material when in a water absorption state, there is no need to use an absorbent material and a moisturizing agent at the same time, unlike in the conventional methods. Furthermore, the humidity conditioner of the present invention is made reusable by repeatedly conducting a water discharge treatment accordingly after water is absorbed, which leads to cost reduction. Besides, the humidity conditioner of the present invention can be effectively used in high humidity environments to which conventional humidity conditioners are less applicable.

Materials for the humidity conditioner of the present invention can be obtained at a relatively low price, and therefore the present invention can be realized while curbing the cost. In addition, the present invention is able to materialize a humidity-conditioning sheet having good resilience by using the above-mentioned reversible and speedy water absorption and discharge functions.

### BRIEF DESCRIPTION OF THE DRAWINGS

FIGS. 1A and 1B show a configuration of a humidity-conditioning sheet 1 according to a first embodiment of the present invention;

FIG. 2 shows a molecular structure of a humidity conditioner (PA/PVA);

FIG. 3 schematically shows a state of the humidity conditioner when water is absorbed;

FIG. 4 schematically shows a water discharge mechanism of the humidity conditioner;

FIG. 5 shows a molecular structure of another humidity conditioner (PA/P-NIPAM);

FIG. 6 schematically shows a water discharge mechanism of the humidity conditioner;

FIG. 7 is measurement data obtained from a first experiment, showing changes in weight (g) of Samples A to E over time;

FIG. 8 is measurement data obtained from the first experiment, showing the amounts of weight changes (g) of Samples A to E over time;

FIG. 9 is measurement data obtained from a second experiment, showing changes in weight (g) of practical and comparative examples X and Y over time after filtration;

FIG. 10 is measurement data obtained from the second experiment, showing the amounts of weight changes (g) of practical and comparative examples X and Y over time after filtration;

FIG. 11 is measurement data on dehydrating effects, showing changes in weight (g) of practical and comparative examples x and y over time;

FIG. 12 is measurement data on dehydrating effects, showing the amounts of weight changes (g) of practical and comparative examples x and y over time;

FIG. 13 is measurement data on dehydrating effects, showing the amounts of water reabsorption of practical and comparative examples x and y after a drying period of 35 hours;

FIG. 14 is measurement data on dehydrating effects, showing the amounts of water reabsorption of practical and comparative examples x and y after a drying period of 1 week;

FIG. 15 is measurement data on dehydrating effects, showing the amounts of water reabsorption of practical and comparative examples x and y after a drying period of 1 month;

FIG. 16 is measurement data on a dehydration capacity of the humidity conditioner, showing changes in weight (g) of Samples a to e over time;

FIG. 17 is measurement data on a dehydration capacity of the humidity conditioner, showing the amounts of weight changes (g) of Samples a to e over time;

FIG. 18 is measurement data on a reabsorption capacity and a succeeding retention capacity of the humidity conditioner, showing the amounts of water reabsorption and changes in weight (g) of Sample a to e over time;

FIG. 19 is measurement data on a retention capacity of the humidity conditioner after the water reabsorption, showing the amounts of weight changes (g) of Sample a to e over time;

FIG. 20 shows a configuration of a garment to which humidity-conditioning sheets according to a second embodiment of the present invention are attached;

FIG. 21 shows a configuration of a nursery pot according to a third embodiment of the present invention;

FIG. 22 shows a configuration of a humidity-conditioning glass according to a fourth embodiment of the present invention;

FIG. 23 shows a configuration of a humidity-conditioning tatami mat according to a fifth embodiment of the present invention;

FIG. 24 shows a configuration of a collapsible container according to a sixth embodiment of the present invention;

FIG. 25 shows a configuration of a case containing a humidity-conditioning sheet according to a seventh embodiment of the present invention; and

FIG. 26 schematically shows a state of a conventional humidity conditioner when water is absorbed.

### BEST MODE FOR CARRYING OUT THE INVENTION

### 1. First Embodiment

1.1 Configuration of Humidity-Conditioning Sheet

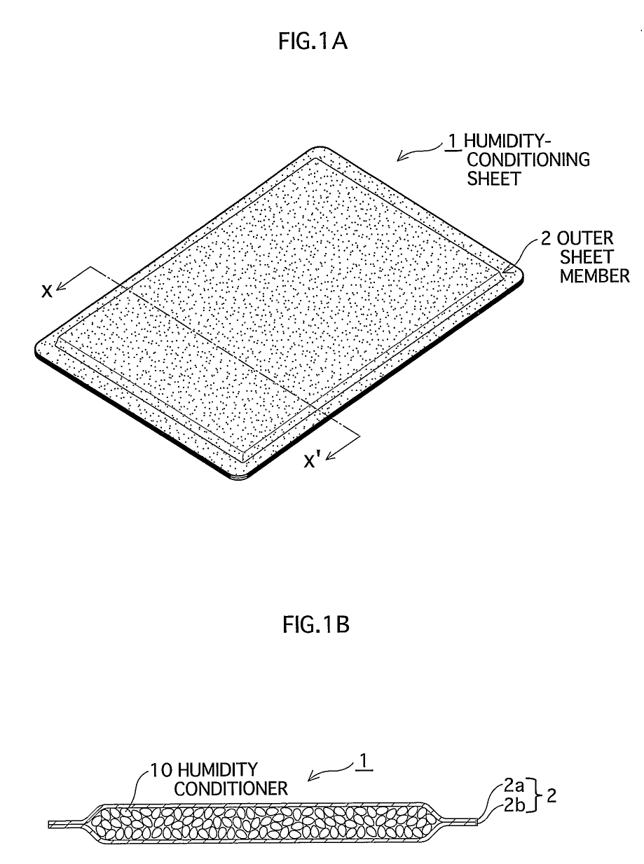

FIGS. 1A and 1B show a configuration of a humidity-conditioning sheet 1 according to a first embodiment of the present invention. FIG. 1A is an external view of the humidity-conditioning sheet 1, and FIG. 1B is a cross sectional view of the humidity-conditioning sheet 1 along the line X-X′.

The humidity-conditioning sheet 1 has a configuration in which a humidity conditioner 10 in a particulate form is filled between two rectangular outer sheet members 2 (2a and 2b), and the hems of the outer sheet members 2a and 2b are sealed. The size of the humidity-conditioning sheet 1 is, for example, 10 cm×6 cm×1 mm.

The outer sheet members 2a and 2b, each of which has a thickness of, for example, approximately 200 μm, are composed of a material having excellent water permeability and a certain degree of mechanical strength, for instance, a non-woven fabric made of cellulosic fibers or aliphatic hydrocarbon fibers, or a microporous film produced by processing polymeric materials. Alternatively, multiple materials from among these may be selected, and stacked in layers to form a laminated structure. The hems of the outer sheet members 2a and 2b are adhered together by, for example, thermocompression bonding, with the particulate humidity conditioner 10 encased with the outer sheet members 2a and 2b.

Each particle of the humidity conditioner 10 is formed in a round or elliptical shape, or a shape similar to these, having an average particle diameter of 2 μm, for example. Specifically speaking, as shown in FIG. 1B, the humidity conditioner 10 is filled between the outer sheet members 2a and 2b at a constant density. At this point, the filling density of the particulate humidity conditioner 10 is preferably adjusted to provide some space between the particles so that the air from outside adequately flows in through the outer sheet members 2a and 2b. The particulate humidity conditioner 10, as the detailed description is given below, reversibly changes its form from a hydrated gel when absorbing water to an original particulate state after discharging water.

Here, the distinguishing characteristic of the first embodiment is using a material having reversible functions of water absorption and discharge for the particulate humidity conditioner 10. Herewith, conventionally impracticable humidity conditioning can be implemented, and yet the humidity-conditioning sheet 1 can be reused. The following makes a specific description of the particulate humidity conditioner 10.

1.2 Structure of Humidity Conditioner

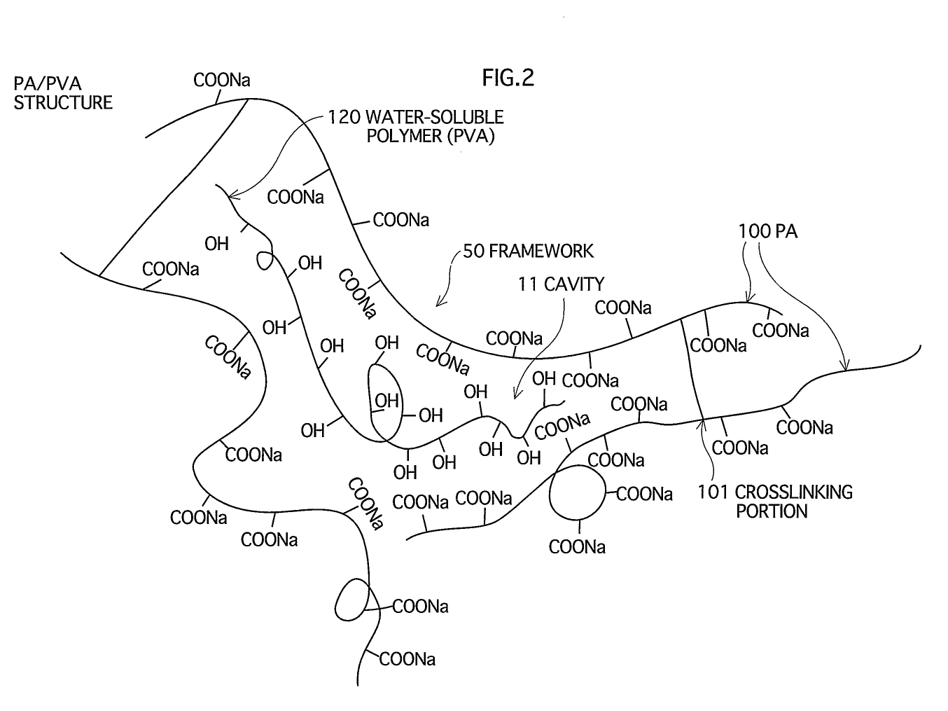

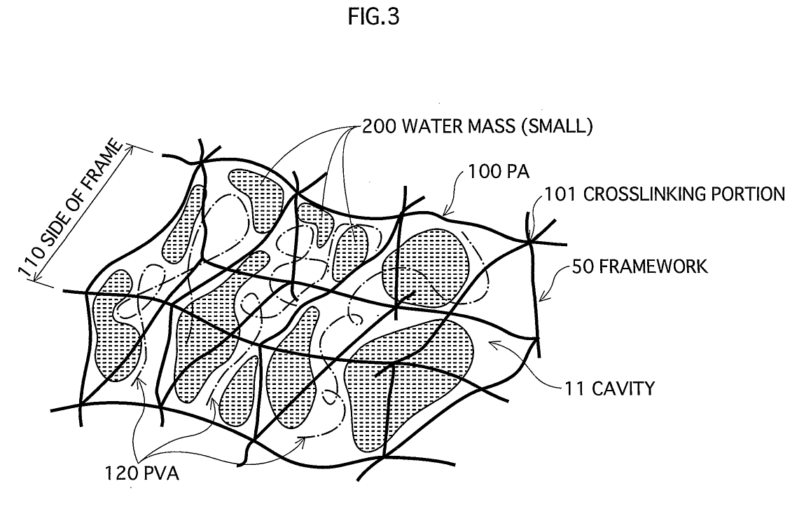

FIG. 2 shows a schematic molecular structure of the particulate humidity conditioner 10.

As shown in the figure, the material of the particulate humidity conditioner 10 has a configuration where polyvinyl alcohol (PVA) 120, which is an example of a water-soluble polymer, is introduced inside cavities 11 of a three-dimensional framework 50. In this three-dimensional framework 50, principal chains composed of sodium polyacrylate (PA) 100 are crosslinked by crosslinking portions 101 (a PA/PVA configuration). The cavities 11 are caused mainly by the electrostatic repulsion of multiple carboxylate ions (negative charges of oxygen atoms) of the PA 100 when water is absorbed. The PA 100 provides an effect of maintaining the humidity conditioner 1 in a water retention state for a certain period of time after water is absorbed.

The three-dimensional framework 50 is formed in a cubic lattice structure (when water is absorbed) by the multiple crosslinking portions 101 and the PA 100 composing the principal chains. Within the framework 50, a distance between two adjacent crosslinking portions 101 is approximately 20 nm, for instance. This distance corresponds to one side 110 of individual cubic frames in the lattice structure, and about a hundred molecules of a sodium acrylate monomer are polymerized on each side 110.

Note here that “cubic” lattice structure is referred to only as ideal structural portions of the three-dimensional framework 50. Practically speaking, there are variations in the locations of crosslinking portions 101, and therefore some portions exhibiting a somewhat altered lattice structure are included in the three-dimensional framework 50.

The PA 100 is a polymeric material having excellent water absorption. In terms of the chemical structure, carboxylate ions work as hydrophilic groups, and the PA 100 is characterized by the water absorption function, with which the PA 100 is capable of absorbing water of hundreds of times its own mass when coming into contact with water. The PA 100 maintains a water absorption state of the particulate humidity conditioner 10 for a certain period of time after water is absorbed.

On the other hand, besides having high water solubility, the PVA 120 exhibits a high water absorption capacity in an aqueous solution, though not to the extent of the PA 100, and has a property of swelling up as taking in water. The PVA 120 is composed of about a hundred molecules of a polyvinyl alcohol monomer being polymerized. While maintaining a linear or a curved conformation, the PVA 120 is held in a manner to entwine itself around the cubic frames of the three-dimensional framework 50 composed of the PA 100. When coming into contact with water taken in the cavities 11, the PVA 120 divides the water into relatively small water masses. Thereby, the PVA 120 reduces surface tensions of the water masses and facilitates the water discharge effect.

The particulate humidity conditioner 10 produces the water discharge effect after a certain period of water retention. Here, the timing at which the water discharge effect occurs can be adjusted by, for example, the amount of the PVA 120 added with respect to the PA 100.

Such PA 100 and PVA 120 are materials largely available to the market, and therefore the present invention can be realized at a comparatively low price.

Regarding materials of the three-dimensional framework 50, a PA-PVA copolymer in which the PVA 120 is included within the principal chains may be used. In addition, the PA 100 is not limited to sodium salts and can be other kinds of salts.

A water-soluble polymer according to the present invention is not confined to either the PVA 120 or P-NIPAM 130, which is described hereinafter, and a mixture of the PVA 120 and P-NIPAM 130, each of which accounts for no less than 10% but no more than 90% of the mixture, can be used instead. Furthermore, if a polymer to be used has water solubility, other compositions may be applicable.

Examples of methods for manufacturing such a humidity conditioner include the following.

<Examples of Manufacturing Methods>

(A) The three-dimensional framework 50 composed of the PA 100 is formed by conducting a crosslinking reaction with a crosslinking ratio of 1%, with the use of commercially available PA 100 (e.g. “AQUALIC DL series” of Nippon Shokubai Co., Ltd.). Alternatively, another commercially available PA 100 can be used on which a crosslinking reaction with the 1% crosslinking ratio has already been conducted (e.g. “RHEOGIC 250H and 252L” of Nihon Junyaku Co., Ltd.).

Note that the crosslinking ratio is not fixed to 1%, and can be changed within the range of no less than 0.5% and no more than 5%.

(B) An aqueous solution including the three-dimensional framework 50 composed of the PA 100 is made, and PVA 120 having a molecular weight of approximately 4400 (corresponding to about a hectamer of a vinyl alcohol molecule) is dissolved in the aqueous solution. The inventors of the present invention have revealed in their experiments that, by setting the PVA 120 to the above molecular weight, the PVA 120 is well introduced inside the cavities 11 in the cubic frames with each side 110 having a width of 20 nm. A molecular weight of PVA suitable for the present invention is in the range of 500 and 20000.

(C) An aqueous solution in which both the PA 100 and the PVA 120 are mixed is made, and left at rest for 1 to 10 hours at ambient temperatures or under heating conditions to thereby introduce the PVA 120 inside the cavities 11 in the three-dimensional framework 50. It is desirable to set the amount of the PVA 120 to be introduced in the range of no less than 1% of the mass of the particulate humidity conditioner 10 that contains no water but no more than 30% of the same.

(D) Water is removed from the mixed aqueous solution including the PA 100 and the PVA 120 to dry and thereby obtain powder. The powder is packed into particles with some degree of size (granulated powder) to obtain the particulate humidity conditioner 10.

Note that the particulate humidity conditioner 10, as is in a form of powder, can be filled in the outer sheet members 2a and 2b. However, in this case, the porosity and pore size of the outer sheet members 2a and 2b need to be adjusted so that the powder will not be spilled outside.

1.3 Humidity Conditioning Method Using Humidity Conditioner and Advantageous Effects of the Same

Regarding the humidity-conditioning sheet 1 using the particulate humidity conditioner 10 having the above configuration, at the point of use, a user installs the humidity-conditioning sheet 1 in a humid atmosphere (e.g. in a grain warehouse desired to be maintained in a dry atmosphere). At the time of installation, the number of the sheets 1 is adjusted according to the installation location and the degree of dehumidification required.

In such a humid atmosphere, after the humidity-conditioning sheet 1 is installed, water vapor in the atmosphere comes into contact with the particulate humidity conditioner 10 via the outer sheet members. Herewith, the water vapor is taken inside the particulate humidity conditioner 10. The particulate humidity conditioner 10 swells in proportion to the amount of water taken in at this point, and the three-dimensional framework 50 becomes a hydrated gel and alters into a cubic structure.

FIG. 3 shows a schematic configuration of the particulate humidity conditioner 10 showing the cubic structure when water is absorbed. As shown in the figure, water vapor is once absorbed inside the cavities 11, and molecules of the water vapor are condensed to form liquid water. Until the water being discharged as hereinafter described, the particulate humidity conditioner 10 remains in a water absorption state, which accordingly the humidity-conditioning sheet 1 exercises an effect of water retention.

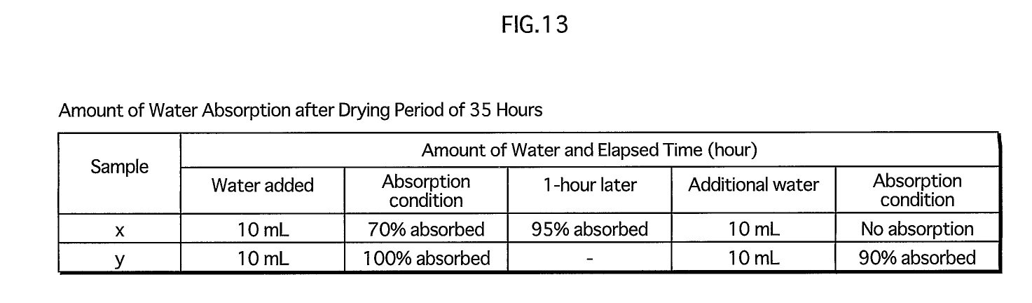

When a certain period of time elapses after the water absorption, the liquid water comes into contact with the PVA 120, and the PVA 120 thereby swells. Then, the liquid water is divided into multiple small water masses inside the cavities due to the pressure received as a result of the PVA 120 swelling, which is a characteristic of the present invention. With the liquid water divided into such small water masses, the particulate humidity conditioner 10 is able to achieve the water discharge effect. FIG. 13 shows a three-dimensional framework (when water is absorbed) of an absorbent material using a conventional water-absorbing polymer (sodium polyacrylate), which is here shown as a comparative example.

In general, liquid water has a surface tension proportional to the surface area. When the surface tension is large, the elastic deformation of the water masses is small even when the water masses touch the cubic frames. As a result, it becomes difficult for the water masses to move over to the outside, and therefore the water masses are retained within the cubic frames, as shown in FIGS. 13A and 13B. In addition, although fundamentally having a high water absorption capacity, the PA 100 does not have an intrinsic water discharge capacity. Thus, the water absorption function is practically irreversible.

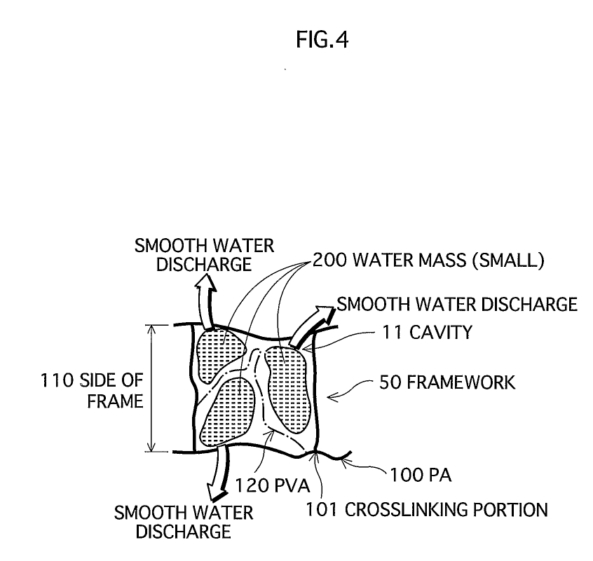

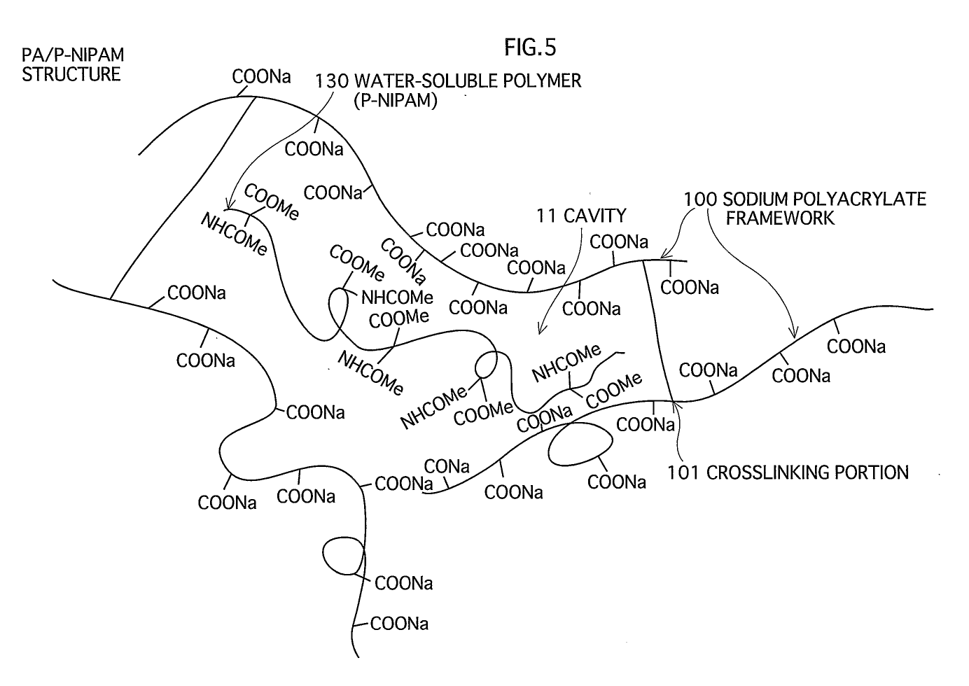

According to the present invention, however, the water discharge function can be exerted besides the water absorption function by structuring the particulate humidity conditioner 10 by incorporating the PVA 120 with the PA 100. Specifically speaking, water taken inside comes into contact with the PVA 120, and is then divided into small water masses 200 within the cubic frames, as shown in FIG. 3. As a result, the surface tension of each Water mass 200 is reduced to a lower level. Herewith, as shown in FIG. 4, when touching against the cubic frames, the water masses 200 undergo significant elastic deformation, which facilitates discharge of the water masses 200 to the outside.

On top of the mechanism, since the PVA 120 swells in contact with water, the swollen PVA 120 acts to push the water masses 200 out of the cubic frames. Therefore, since having become relatively easier to slip through between the cubic frames, the small water masses 200 will be readily discharged when receiving the pressure from the PVA 120 as described above. Then, the particulate humidity conditioner 10 after the water is discharged further dehydrates to restore to the original state before being used. Herewith, the particulate humidity conditioner 10 is capable of achieving reversible operations between the water absorption and discharge mechanisms that have been conventionally impossible. The timing for exercising the water discharge effect can be delayed by reducing the above-mentioned discharge effects accelerated by the PVA 120 (i.e. the degree of division of the small water masses 200 and an action of pushing out the water masses 200 due to the swelling of the PVA 120). Therefore, by taking note of this point, it is possible to achieve adequate humidity conditioning.

The reversible functions of water absorption and discharge, which are achieved by incorporating the PVA 120 with the PA 100, have been revealed for the first time, owing to keen examinations conducted by the inventers of this application. To rephrase, although the water absorption effects of water-absorbing polymers, such as the PA 100, have commonly been researched to some extent in the past, only a small number of studies have been made on the water discharge effects, which are opposite effects to the water absorption effects. Against this background, the inventors of this application have accomplished the present invention by making a profound study on the water discharge function in terms of properties of polymers and the surface tension of water. Having the reversible functions of water absorption and discharge is a distinctive difference of the particulate humidity conditioner 10 of the present invention from a simple, conventional absorbent material (see FIG. 13) simply made up of the PA 100 and the like as the main materials.

It is possible to reduce, to some degree, the water content of an absorbent material that uses a water-absorbing polymer composed of commonly well-known PA by leaving the absorbent material under dry conditions. However, such a reduction in water content results from very little drying occurring mainly in the vicinity of the surface of the absorbent material. When compared with a reduction in water content realized by the water discharge function of the particulate humidity conditioner 10 of the present invention, the water content reduction of the absorbent material is significantly small, and therefore it can be hardly said that the absorbent material has an effective water discharge function.

Note that, regarding the particulate humidity conditioner 10, the rate of discharging the absorbed water to the outside can be adjusted by modulating the amount of the PVA 120 introduced into the cavities 11.

<Other Methods for Adjusting Water Discharge>

In addition to the above example where a method for adjusting the water discharge using the dividing effects by the PVA 120 to form small water masses 200 is shown, there are other methods for water discharge adjustments. Next is described a method for adjusting water discharge by a treatment using a sodium chloride (NaCl) solution.

That is, when the particulate humidity conditioner 10 is in a water absorption state (a state shown in FIG. 3), a solution of sodium chloride is added to the humidity-conditioning sheet 1. At this point, the concentration of the sodium chloride solution should be set in a range no less than 0.01 M but no more than 3 M, and more preferably in a range no less than 0.1 M but no more than 1 M. These numerical figures have been revealed in experiments conducted in order to achieve significant effects of the present invention.

Thus, the NaCl-solution treatment of adding the sodium chloride solution allows rapid water discharge due to the effect of reverse osmosis. That is, by adding sodium chloride to the particulate humidity conditioner 10 which is in the form of a hydrated gel at the water absorption, a dehydration phenomenon takes place inside of the cubic frames, and consequently the particulate humidity conditioner 10 is restored to a dry state. In addition, since the PA 100 includes sodium components, the particulate humidity conditioner 10 does not receive an adverse effect from the sodium chloride.

Note that, if this water discharge adjustment is repeatedly performed, the concentration of sodium chloride components included in the humidity-conditioning sheet 1 is naturally increased. If the concentration of sodium chloride becomes too high, the ion balance (a balance between carboxylate ions and sodium ions of PA 100) of the humidity conditioner 10 at the time of water absorption is, for example, affected. Therefore, it is desirable to do maintenance on the humidity-conditioning sheet 1 by rinsing with fresh water accordingly to remove the saline matter.

1.4 Variations of Water-Soluble Polymers

As to the configuration of the particulate humidity conditioner 10 described above, provided is an example in which the PVA 120 is used as the water-soluble polymer. However, the present invention is not confined to the PVA 120, and can use polyisopropylacrylamide (P-NIPAM), which is a different type of water-soluble polymer.

FIG. 5 shows a schematic structure of the particulate humidity conditioner 10 using P-NIPAM 130. While the three-dimensional framework is composed of the PA 100, molecules of P-NIPAM 130 (e.g. a molecular weight of approximately 12000) are introduced into the cavities 11 within the three-dimensional framework, and arranged to entwine themselves around the framework. It is desirable to set the amount of the P-NIPAM 130 to be introduced, as is the case with the PVA 120, in the range of no less than 1% of the mass of the particulate humidity conditioner 10 that contains no water but no more than 30% of the same.

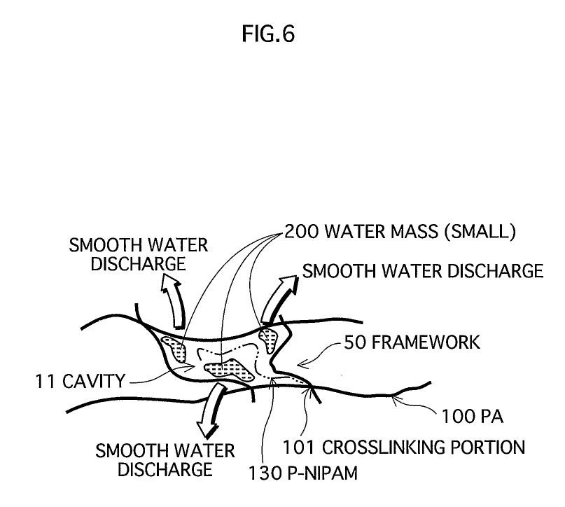

The P-NIPAM 130 is a thermosensitive water-soluble polymer that exhibits a transition from a water-soluble to a water-insoluble state in response to temperature. While being in the form of white powder at an ambient temperature of 25° C., the P-NIPAM 130 becomes clouded and transforms to a hydrated gel when absorbing water. If the P-NIPAM is pure, the hydrated gel P-NIPAM 130 exhibits a water discharge function when heated up to about 60° C. FIG. 6 schematically shows an aspect of the water discharge at this point. The water masses 200 are readily discharged from the P-NIPAM 130 to the outside by heat. After that, the P-NIPAM 130 can be restored to its original state by lowering the temperature to around 10° C.

Note that a molecular weight of P-NIPAM suitable for the present invention is in the range of no less than 1000 but no more than 30000.

The temperature range yielding the water discharge function can be fine-tuned by changing the molecular structure of the P-NIPAM 130 in part by, for example, replacing the substituents of the P-NIPAM 130 or copolymerizing the P-NIPAM 130 with another type of vinyl polymer.

Thus, when the thermosensitive P-NIPAM 130 is used as the water-soluble polymer for the particulate humidity conditioner 10 of the present invention, the water discharge function can be exercised by just conducting the temperature treatment after the water absorption. This brings about a great advantage of being able to easily make the particulate humidity conditioner 10 reusable.

1.5 Practical Examples and Performance Measurement Experiments

Although intrinsically having excellent water absorption and retention capacities, sodium polyacrylate, which is a conventionally used water-absorbing polymer, has a poor discharge capacity. By contrast, the present invention improves the water discharge capacity by introducing polyvinyl alcohol into the framework composed of the sodium polyacrylate.

The following describes performance measurement experiments conducted on the humidity conditioner of the present invention as well as various materials used for the humidity conditioner, and states evaluations for their performance.

The materials used are as follows.
water: tap water (Kyotanabe-city water)

This water is not, what is called, a hard water, and taken as an example of a type of water that contains substantially no alkaline metals other than sodium and no alkaline-earth metals.
powdered water-absorbing polymer (sodium polyacrylate (PA)): a water-absorbing polymer, “Sunfresh ST-250” manufactured by Sanyo Chemical Industries, Ltd.
powdered PVAs: manufactured by Wako Pure Chemical Industries, Ltd. The details are as follows:
Sample 1 (PKK7651): average degree of polymerization—500;
Sample 2 (PKP0052): average degree of polymerization—1500;
Sample 3 (PKE1780): average degree of polymerization—2000;
Sample 4 (ASH2008): average degree of polymerization—500 (complete saponification 400-600);
Sample 5 (ASH2009): average degree of polymerization—1000 (complete saponification 900-1100);
Sample 6 (ASM7302): average degree of polymerization—1000 (partial saponification 900-1100); and
Sample 7 (ASL1312): average degree of polymerization—3500 (partial saponification 3100-3900).
   1.5.1 Aqueous Solubilities of PVAs

The aqueous solubilities of the PVAs were investigated in the following manner.

First, aqueous solutions for respective PVA Samples 1 to 7 above were made, a specified amount of the water-absorbing polymer (sodium polyacrylate) was added to each of the solutions to create a mixed suspension, and the suspensions were left at rest over a sufficient period of time. Subsequently, the suspensions were filtrated, and then changes in weight of (PVA+PA) before and after the water absorption were examined.

Note that the heating temperature was set to about 80° C. in the case when a heat treatment was performed.

<Results>

Sample 1: 1.0 g of the PVA sample well dissolved in 10 mL water under the heating condition;
Sample 2: 0.14 g of the PVA sample dissolved in 5 mL water under the heating condition;
Sample 3: 0.11 g of the PVA sample dissolved in 5 mL water under the heating condition;
Sample 4: 0.10 g of the PVA sample dissolved in 5 mL water at ambient temperatures;
Sample 5: 0.10 g of the PVA sample dissolved in 10 mL water under the heating condition;
Sample 6: 0.10 g of the PVA sample dissolved in 10 mL water under the heating condition; and
Sample 7: 0.10 g of the PVA sample dissolved in 10 mL water under the heating condition.

Through this experiment, the amount of water absorption required to dissolve 1 g of each PVA sample was calculated as follows:
Sample 1: 10 mL;
Sample 2: 35.71 mL;
Sample 3: 45.45 mL;
Sample 4: 50 mL;
Sample 5: 100 mL;
Sample 6: 100 mL; and
Sample 7: 100 mL.
   1.5.2 Amount of Water Absorption of PA

The amount of water absorption of the above water-absorbing polymer (PA) was investigated in a manner described below, and the following findings were obtained.

When 20 mL water was added to 0.21 g of the PA sample, the result turned into a gel state having no fluidity.

When 100 mL water was added to 0.10 g of the PA sample, the result remained in a fluid state due to excess water. Then, further 0.10 g of the PA sample was added to the result, and a gel state having no fluidity was obtained.

Through the experiment, it is thought that the upper limit of the amount of water that the PA absorbs is 500 to 1000 times its own weight.

1.5.3 Water Discharge Effect of PA

Next, the water discharge effect exercised by sodium chloride of the above water-absorbing polymer was investigated in the following manner.

First, a hydrated gel was made by adding 20 mL water to 0.21 g of the PA sample.

Then, 1 mL of an aqueous solution containing 0.11 g of sodium chloride was added to the hydrated gel.

However, at this stage, no change was observed.

Subsequently, when further 1.02 g of sodium chloride was added, the result exhibited fluidity, and a dehydrating effect was observed.

Through the experiment, it has become apparent that a dehydration treatment can be accomplished by adding 1.13 g of sodium chloride in the case of 100 mL water being absorbed by 1 g of the PA.

On the other hand, a hydrated gel was made by adding 100 mL water to 0.20 g of the PA sample in a container.

When 0.52 g of sodium chloride was added to the hydrated gel, water was discharged from the gel, and subsequently a state where the gel was floating in the discharged water was obtained.

According to the above experiment, it has become evident that, in the case where a hydrated gel is made by adding 500 mL water per 1 g of the PA, the dehydration can be achieved by adding 0.52 g of sodium chloride, and thus the filtration is facilitated.

1.5.4 Measurements on Water Retention Performance (First Experiment)

Next, five types of Samples A to E were prepared, and the first experiment on the water retention capacity of the humidity-conditioning sheet (PA/PVA) according to the present invention was conducted using the samples in an environment at temperatures between 18° C. and 22° C.

Sample A: [0.1 g PA+no PVA added+100 mL water];

Sample B: [0.1 g PA+0.1 g PVA Sample 1+100 mL water];

Sample C: [0.1 g PA+0.05 g PVA Sample 1+100 mL water];

Sample D: [0.1 g PA+0.1 g PVA Sample 6+100 mL water]; and
Sample E: [0.1 g PA+0.1 g PVA Sample 7+100 mL water].

Each of Samples Ato E was filtrated, and changes in weight of the samples were examined over time for a period of about 7.5 days immediately after the filtration.

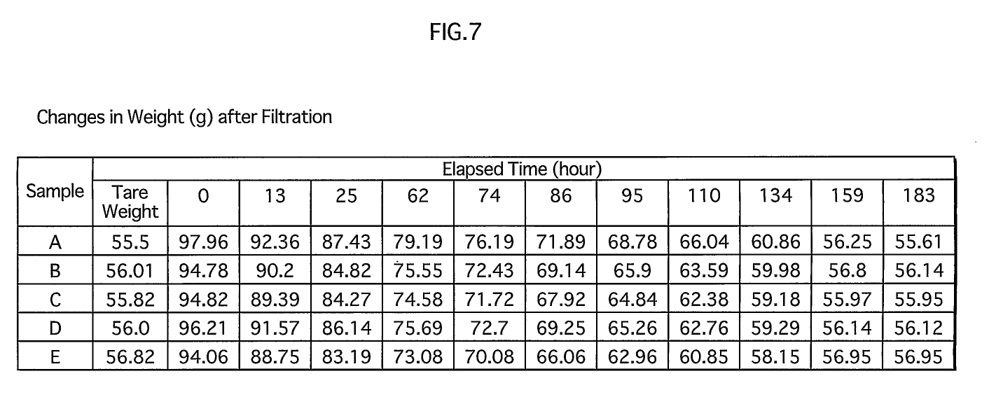

The results were shown in FIG. 7. “Tare” in FIG. 7 and subsequent figures refers to the outer sheet members of the humidity-conditioning sheet.

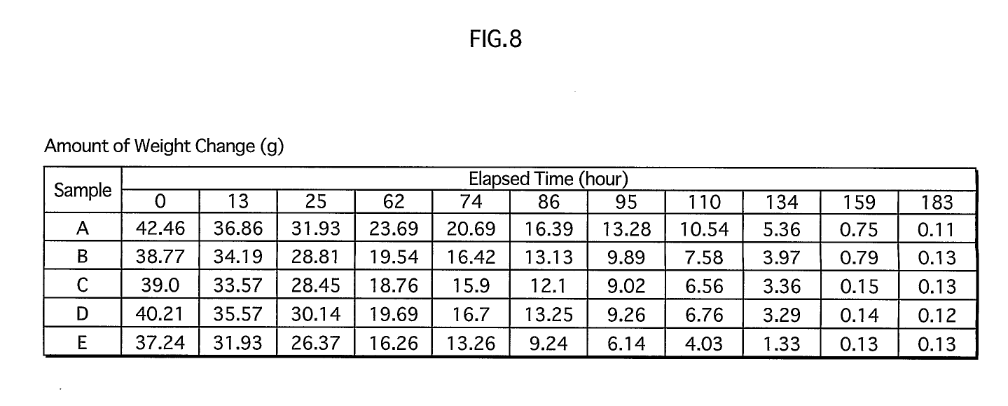

In addition, FIG. 8 shows the results indicating only the amounts of weight changes (g) over time, calculated based on the data shown in FIG. 7.

<Considerations>

As indicated in tables of FIGS. 7 and 8, the PVA-added Samples B to E exhibited largely similar water absorption capacities, contrary to Sample A to which no PVA was added. Regarding the amount of weight change over time after the water absorption, equivalent performance of retaining water was observed in all samples at least within 183 hours following the water absorption.

The results are thought of as indicating that the humidity-conditioning sheet of the present invention has a water absorption capacity equivalent to that of a water-absorbing material using conventional PA.

1.5.5 Measurements on Water Retention Performance (Second Experiment) a

Next, the second experiment on the water retention capacity of the humidity-conditioning sheet (PA/PVA) according to the first embodiment was conducted in order to examine behaviors of the humidity-conditioning sheet at the time when a comparatively large amount of PVA is added with respect to the PA.

To be specific, here as a practical example X, a suspension was prepared by mixing 200 mL water with [0.3 g PA+20 g PVA Sample 1 (i.e. PA/PVA ratio=0.015)].

On the other hand, as a comparative example Y, another suspension was prepared by mixing 200 mL water with [0.3 g PA+no PVA added].

Then, respective suspensions were filtrated, and the subsequent changes in weight over time were examined.

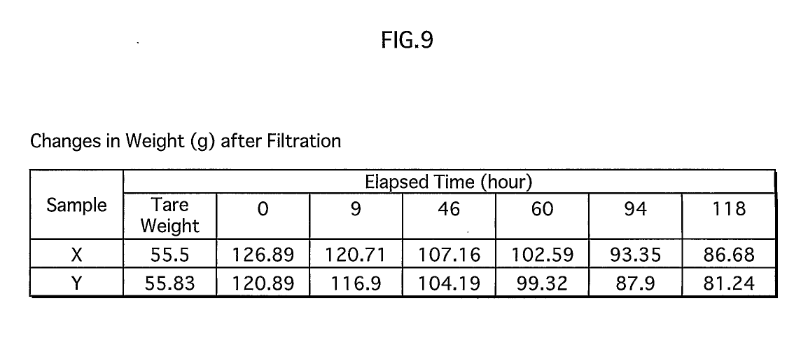

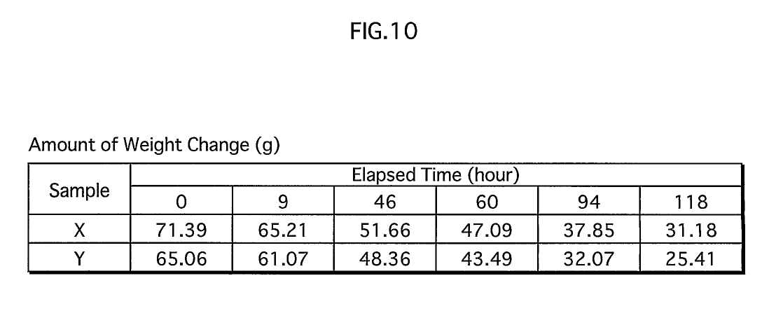

The results are shown in FIGS. 9 and 10.

<Considerations>

Although the practical example X had 3 and 200 times the amounts of the PA and PVA, respectively, as compared to Samples A to E, the amount of water absorption of the practical example X hardly even doubled. Accordingly, it is assumed that water may not be sufficiently retained in the three-dimensional framework composed of the PA unless the ratio of the PV to the PVA used is adequately controlled.

Note that the practical example X exhibited a higher water retention capacity than the comparative example Y due to the swelling of the large amount of PVA.

1.5.6 Measurement of Dehydrating Effect

Here, in order to measure the dehydrating effect of the humidity-conditioning sheet (PA/PVA) according to the first embodiment, a suspension was prepared as a practical example x by mixing 100 mL water with [0.15 g PA+10 g PVA Sample 1].

On the other hand, another suspension was prepared as a comparative example y by mixing 100 mL water with [0.15 g PA+no PVA added].

At six hours after the suspensions were made, 2.5 g of sodium chloride was added to each of the examples x and y. Then, the results were filtrated to examine the subsequent changes in weight. The temperature at the experiment was in the range of 18° C. to 23° C.

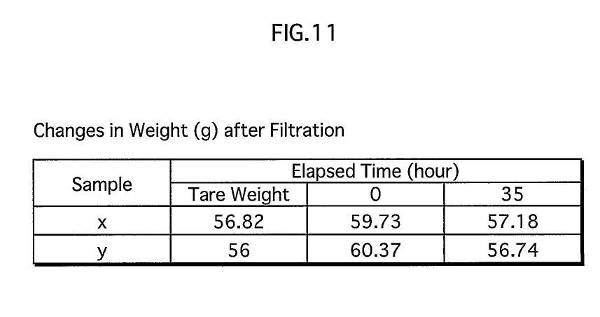

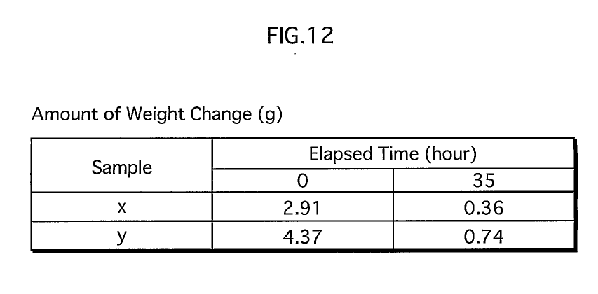

The results of the experiment are shown in FIGS. 11 and 12.

<Considerations>

Compared to the comparative example y, the practical example x showed a lower amount of water absorption since the PVA was added to the PA.

The comparative example y exhibited a higher water discharge effect than the practical example x after sodium chloride was added. This is thought to be attributable to the amount of sodium chloride added. That is, regarding the practical example x, the added amount of sodium chloride was not enough to cause a sufficient water discharge, and consequently the water retention capacity was maintained by the PVA.

Next, multiple suspensions were prepared for each the practical and the comparative examples x and y, and were dried for 35 hours, one week, or a month after the water absorption.

Then, a reabsorption process was conducted to have the dried suspensions absorb water again, and the water absorption capacity at this point was examined for each.

The results are shown in FIGS. 13 to 15.

<Considerations>

According to the results shown in FIG. 13, the practical example x became absorbent again when 35 hours elapsed after the water absorption. While the comparative example y entirely absorbed a certain amount of given water over a short period of time since no PVA was added, the practical example x maintained a water-absorbing function over time because the PVA swelled gradually so that all the water was not absorbed immediately.

At one hour after the start of the water reabsorption, both the examples x and y regained about 90% or more of the original water absorption capacities. However, unlike the practical example x, the comparative example y did not exhibit a function to absorb water gradually. In addition, the visual observation by the experimenters revealed that the practical example x showed smaller volume expansion with the water absorption compared to the comparative example y. These results support that the comparative example y has a configuration specialized for a water-absorbing function.

From here onwards, it is apparent that the practical example x has both a time-lapse water-absorbing function and a water-retaining function after water absorption, which are lacking from the comparative example y.

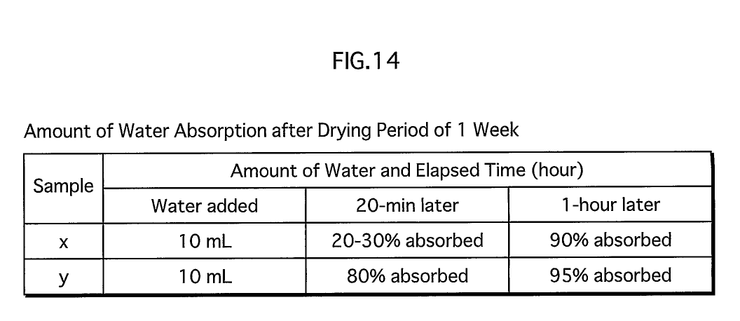

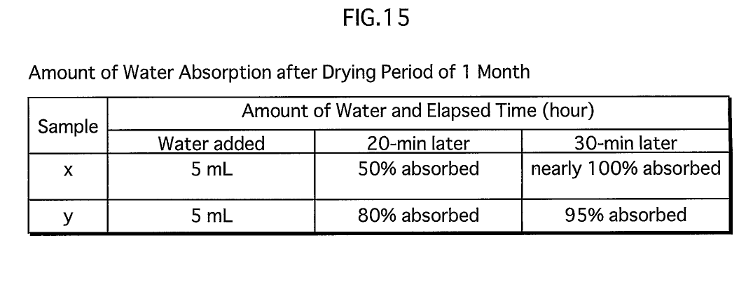

According to the results shown in FIGS. 14 and 15, it can be seen that, as to the water-absorbing function, both the practical and comparative examples x and y almost restored their original capacities after one week or more elapsed even when they had once absorbed water. In the succeeding time periods, the rate of water absorption of the practical example x slowed down to a certain degree, however it is presumed that the degree of the slowdown would not be a problem in the actual use.

1.5.7 Dehydration Capacity of Humidity Conditioner

Next, six types of samples (a, b, c, c′, d and e) were prepared by reducing the amount of the PVA used for the practical example x, and the following experiment was conducted on the dehydration capacity of the humidity conditioner (PA/PVA) according to the first embodiment using the samples in an environment at temperatures between 18° C. and 22° C.
Sample a: (0.1 g PA+no PVA added+20 mL water);
Sample b: (0.1 g PA+1.0 g PVA Sample 2+20 mL water);
Sample c: (0.1 g PA+1.0 g PVA Sample 4+20 mL water);
Sample c′: (0.1 g PA+1.0 g PVA Sample 4+20 mL water);
Sample d: (0.1 g PA+1.0 g PVA Sample 6+20 mL water); and
Sample e: (0.1 g PA+1.0 g PVA Sample 7+20 mL water)

After the samples were left at rest for three hours, 1.0 g of sodium chloride was added to each of the samples. Then, the samples were filtered, and changes in weight were examined over time immediately after the filtration.

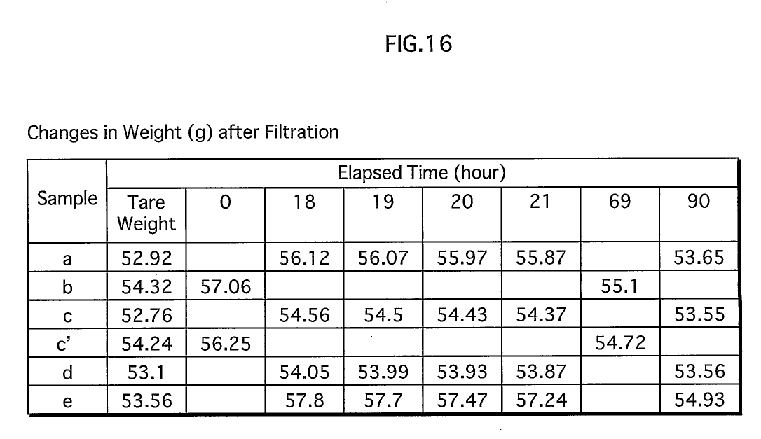

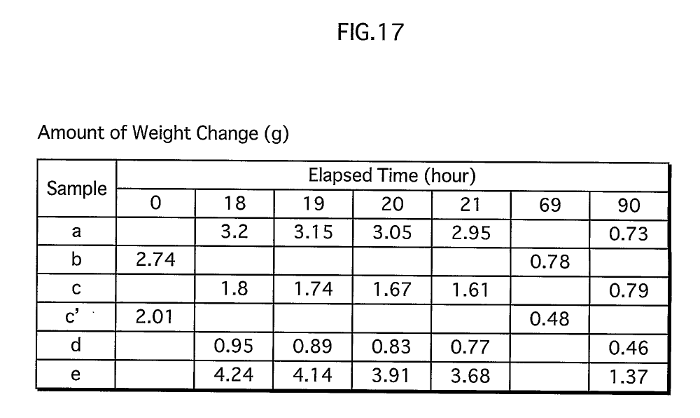

The results are shown in FIGS. 16 and 17.

<Considerations>

It has been understood that Samples b to e, in which the amount of the PVA used was less than that used in the practical example x, had water discharge rates equivalent or slightly slower than Sample a where no PVA added.

In addition, it became apparent that there was little effect of variations in characteristics and the like concerning the average degree of polymerization and the degree of saponification of the PVA.

Subsequently, Samples a to e, on which the water absorption process had been conducted and sodium chloride had been added, were dried for 35 hours, and the respective samples were made to absorb water once again. The amount of water absorption at this point and succeeding time-lapse changes in the amount of water absorbed were examined.

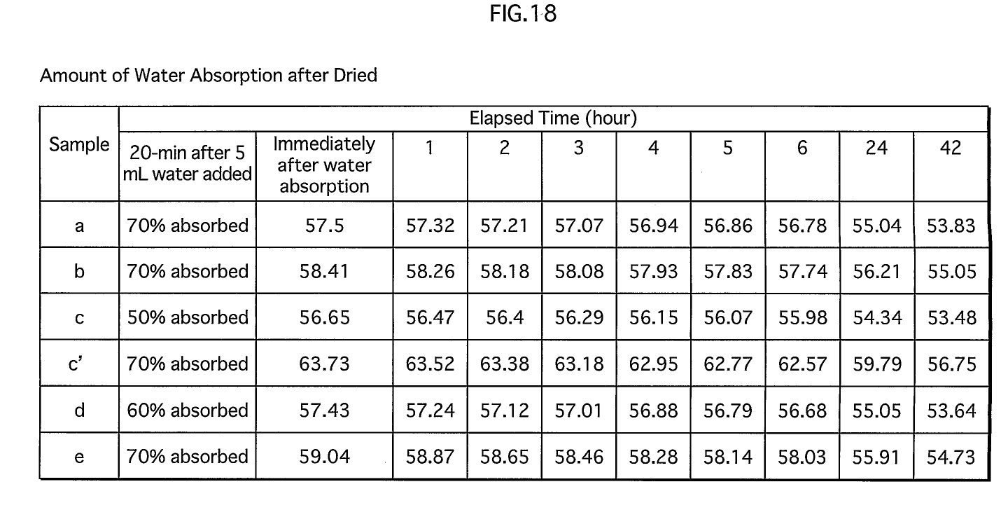

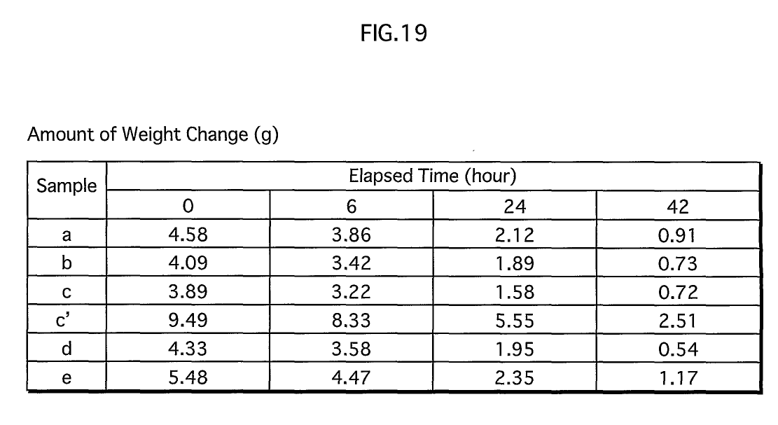

The results are shown in FIGS. 18 and 19.

<Considerations>

Through the data shown in FIGS. 18 and 19, it can be seen that, although the amount of water absorption when water was added again varied in the range between 50% and 70% of the initial absorption, the samples virtually became reusable through the drying treatment.

According to the data in the tables shown in FIGS. 7 to 19, the following procedure can be thought of as an exemplary method for making the humidity conditioner of the present invention:

(1) dissolving 1 g of PVA having a relatively small molecular weight in 10 mL water to make a solution, and, at this point, heating the solution, if needed;

(2) adding 0.15 g of PA to (1) and having the result swell in about two hours;

(At this stage, the PVA is introduced into the PA framework.)

(3) adding 1.0 g of sodium chloride to (2), and agitating the mixture well;

(4) filtrating (3) and retrieving PA/PVA that have absorbed water; and

(5) letting (4) dry for one day.

In this way, the humidity conditioner of the present invention can be produced.

### 2. Second Embodiment

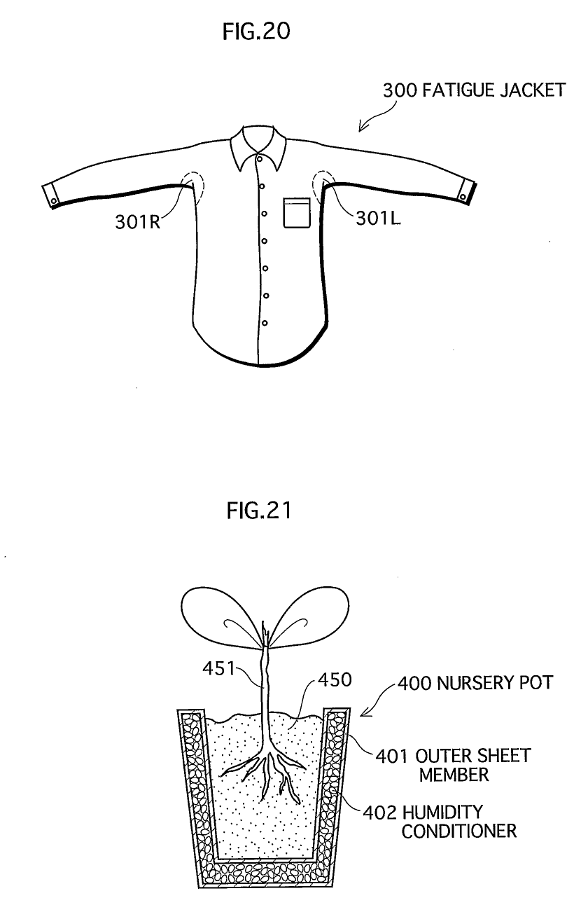

FIG. 20 shows an example where the humidity-conditioning sheet 1 of the first embodiment is applied to clothing (a fatigue jacket) 300. In a second embodiment, the humidity-conditioning sheets 1 are attached to both underarm parts 310R and 310L of the fatigue jacket 300 from the inside in a detachable manner. In order to implement the humidity-conditioning sheets 1 in a detachable way, hook and loop fasteners (e.g. “magic tape” manufactured by Kuraray Co, Ltd.) may be used. Alternatively, two-sided tapes can be employed and laid on the surface of the outer sheet members 2a and 2b of the humidity-conditioning sheets 1. The humidity-conditioning sheets 1 may be set at other than the underarm parts (e.g. around a neckline and a waist).

Such a configuration allows to absorb sweat of a user wearing the fatigue jacket 300 in the case where the humidity-conditioning sheets 1 are used in a dry state. Herewith, it is possible to continue providing comfort to the user while maintaining breathability of the clothing. In addition, the humidity-conditioning sheets 1 can be reused after being used by detaching them from the fatigue jacket 300 and discharging water from the humidity-conditioning sheets 1 being in a water absorption state through, for example, a drying treatment using water masses 200 created by the PVA 120 as described above, a NaCl-solution treatment, or a heating treatment in the case where the P-NIPAM 130 is used.

Note that, although the humidity-conditioning sheets 1 do not necessarily have to be detachable from the fatigue jacket 300, making them detachable has an advantage of avoiding inadvertent damage to the humidity-conditioning sheets 1 since the fatigue jacket 300 can be washed separately.

Applying the humidity-conditioning sheet 1 to the fatigue jacket (clothing) 300 has been here given as an example of use of the humidity-conditioning sheet 1. However, the humidity-conditioning sheet 1 or the particulate humidity conditioner 10 may also be set inside of a hat and a helmet. This is desirable since a steamy heat drawn from a wearer's head is reduced to thereby provide comfort to the wearer.

### 3. Third Embodiment

FIG. 21 is a partial cross sectional view of the humidity-conditioning sheet 1 molded into a shape of nursery pot, showing a usage example of the humidity-conditioning sheet 1 of the first embodiment. The nursery pot 400 shown in the figure has practically the same configuration as the humidity-conditioner sheet 1 described above. That is, a granular humidity conditioner 402 is encased inside of a pot-shaped outer sheet member 401. The nursery pot 400 measures, for example, 5 cm in diameter and 8 cm in height on average. The nursery pot 400 is designed to hold a seedling 451 with soil 450. In order to mold the nursery pot 400, the commonly used extrusion molding can be employed.

The nursery pot 400 having such a configuration is capable of protecting the seedling 451 from drying out for a certain period of time by, for example, setting the nursery pot 400 in a water absorption state by having it absorb water in advance so as to be able to maintain the water retention capacity. Specifically speaking, in the case where the granular humidity conditioner 402 is composed of the PA/PVA, the amount of the PVA 120 to be added is reduced. On the other hand, in the case where the granular humidity conditioner 402 is composed of the PA/P-NIPAM, the conditioner 402 is capable of maintaining the water retention capacity as it is when used at room temperatures. Therefore, by using the nursery pots 400, it is possible to raise the implantation success rate, for example, in a dry land environment, and thus the nursery pots 400 can be effectively utilized in the greenery business and such. Especially in deserts, it is sometimes the case that the temperature rises as high as 50° C. during the daytime, and contrarily, the nighttime temperature drops extremely low to or below the freezing point. At such low temperatures, a thick water vapor forms close to the ground surface. Using the nursery pot 400 of the present invention in an environment like this allows, by having the nursery pot 400 absorb water vapor during the nighttime, to maintain the water retention state during the daytime. Thus, it is possible to prevent the seedling 451 planted in the nursery pot 400 from drying out, and thereby the seedling 451 is able to grow well.

Other than this, it is also anticipated to achieve an effect of facilitating large-volume aerial seeding and planting of seedlings from planes using the nursery pot 400 in a portable mode.

In the case where the seedling 451 dislikes high humidity conditions, it is possible to protect the seedling 451 from the high humidity conditions by setting the nursery pot 400 in a dry state in advance so as to be able to maintain the water absorption capacity. Specifically speaking, in the case where the granular humidity conditioner 402 is composed of the PA/PVA, the amount of the PVA 120 to be added is increased. On the other hand, in the case where the granular humidity conditioner 402 is composed of the PA/P-NIPAM, the molecular structure of the P-NIPAM 130 is changed by adjusting the substituents so that the water discharge can be facilitated under certain environmental conditions.

### 4. Fourth Embodiment

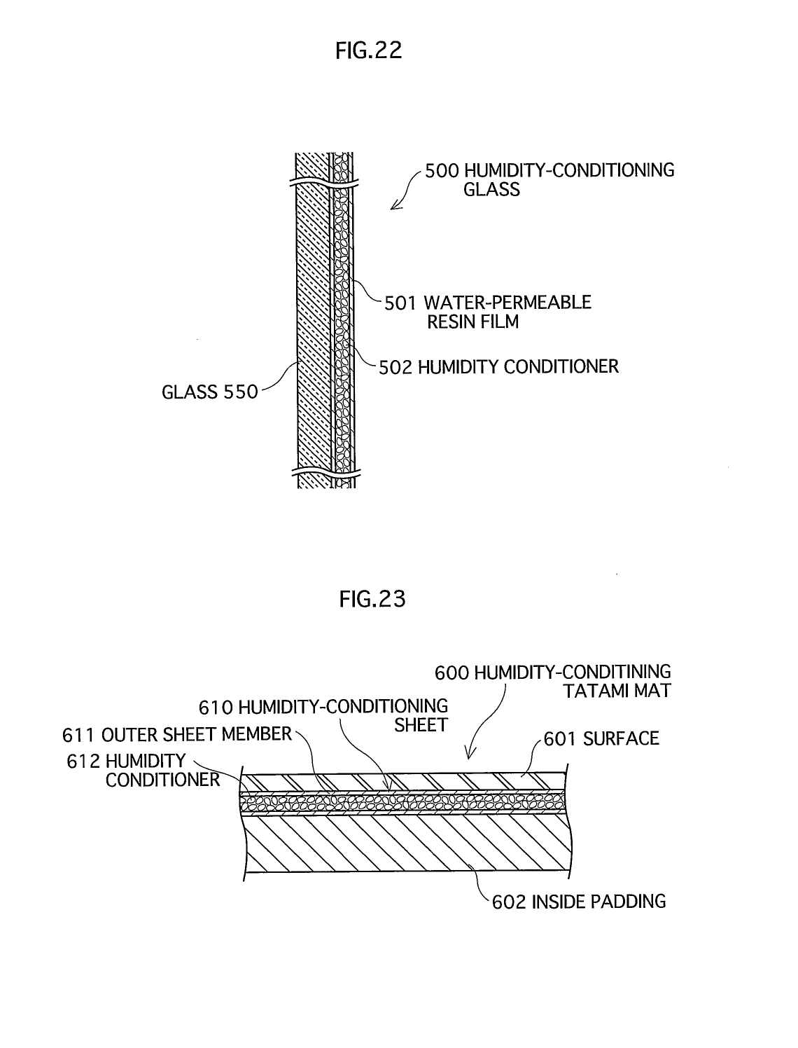

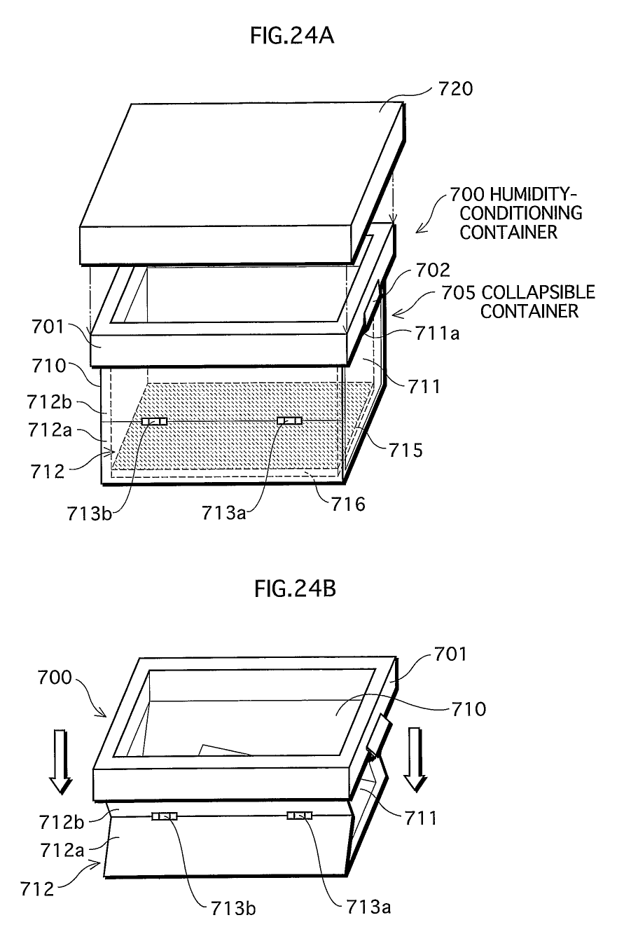

FIG. 22 is a cross sectional view showing a configuration of a humidity-conditioning glass 500 that is a building material applying the humidity conditioner of the present invention. The humidity-conditioning glass 500 shown in the figure, which can be used as a general building material, includes a soda lime glass 550 on one side (or, may be both sides) of which a humidity-conditioning layer is formed. The humidity-conditioning layer is composed of a water-permeable resin film 501 and a granular humidity conditioner 502, with the granular humidity conditioner 502 encased with the water-permeable resin film 501. The humidity conditioner 501 can be made from the same materials as the above humidity conditioner 10.

Such a configuration allows to repeatedly perform humidity conditioning of indoor air (i.e. absorbing water at high humidity, and discharging water in a dry condition) by setting up the humidity-conditioning glass 500 with the humidity-conditioning layer facing indoors. In order to perform the humidity conditioning adequately, it is preferable to use the humidity conditioner 502 composed of the above PA/PVA. Herewith, small water masses 200 are formed in the framework 50, and the water discharge effect described above is thereby accelerated.

The humidity-conditioning glass 500 can achieve an effect of colored glass when the humidity conditioner 502 composed of the above PA/P-NIPAM is applied. That is, although being normally transparent, the P-NIPAM 130 has a characteristic of becoming clouded and gelatinized after absorbing water. In view of this characteristic, the humidity-conditioning glass 500 is placed with the humidity-conditioning layer facing outdoors. Herewith, when it is raining or snowing, the glass surface becomes clouded due to the water absorption, and the humidity-conditioning glass 500 turns into a frosted glass. In other weather conditions, the humidity conditioner 502 is in a dry state, and therefore the humidity-conditioning glass 500 takes on a transparent appearance. Furthermore, in the case where the humidity-conditioning layers are formed on the both sides of the glass 550, the effect of conditioning indoor humidity as well as the colored-glass effect can be obtained.

### 5. Fifth Embodiment

A tatami mat is used as a traditional Japanese floor covering, and the present invention is also applicable to this flooring material. FIG. 23 is a cross sectional view showing a configuration of a humidity-conditioning tatami mat 600 that is a building material applying the humidity conditioner of the present invention. The humidity-conditioning tatami mat 600 shown in the figure has a configuration where a humidity-conditioning sheet 610 is set in a general tatami mat, being placed between a surface 601 and an inside padding 602. Here, the humidity-conditioning sheet 610 has almost the same configuration as the humidity-conditioning sheet 1 of the first embodiment. The humidity-conditioning tatami mat 600 measures, for example, 95.5 cm (length) by 1910 cm (width) by 5.5 cm (height).

The surface 601 can be woven from natural rush grass, or alternatively can be made of artificial fibers, pulp, or the like. The surface 601 for the humidity-conditioning tatami mat 600 of the fifth embodiment is preferably made by weaving fibrous materials in order to ensure the breathability to the humidity-conditioning sheet 610. In the case when materials for a tatami-mat surface used for Judo flooring and the like are used, it is desirable to ensure the breathability by processing the tatami surface so as to have a porous structure by the same token.

The tatami padding 602 that corresponds to a core body of the tatami mat is composed of straws, or alternatively materials such as foam polystyrene and insulation boards (boards for preventing vibration).

The humidity-conditioning sheet 610 has the same configuration as the humidity-conditioning sheet 1, and contains granular humidity conditioner 612 encased with an outer sheet member 611. The humidity-conditioning sheet 610 may have the same size as the humidity-conditioning sheet 1. In this case, however, multiple humidity-conditioning sheets need to be laid for each tatami mat, and therefore, in view of labor effectiveness, the humidity-conditioning sheet 610 may be made in a large size complying with the planar dimension of the humidity-conditioning tatami mat 600.

When the humidity-conditioning tatami mat 600 having such a configuration is used in a normal or a high humidity environment, moisture is taken into the humidity conditioner 612, which leads to sufficient elimination of moisture. Thus, an excellent humidity conditioning effect of indoor air can be achieved. Here, if the PA/PVA are used for materials of the humidity conditioner 612, the humidity-conditioning sheet 610 can be made reusable by accelerating the water discharge so as to restore the initial state. This can be accomplished by, for example, exposing the humidity-conditioning sheet 610 to dry conditions or conducting the above-mentioned NaCl-solution treatment following a certain period of use. On the other hand, in the case where the PA/P-NIPAM is used for the humidity conditioner 612, the humidity-conditioning sheet 610 can be made reusable by restoring it to the initial state by accelerating the water discharge through a heat treatment after the water absorption.

In the case where the air in a room is basically in a dry condition, the air can be maintained in a water-retained condition for a certain period of time by setting the humidity-conditioning sheet 610 in a water absorption state in advance. In this case, moisture is released into the room from the humidity conditioner 612 via the outer sheet member 611 and the surface 601 over an extended time. Therefore, it is desirable that the surface 601, in particular, is made of water resisting materials, such as artificial fibers.

### 6. Sixth Embodiment

FIG. 11 shows a configuration of a humidity-conditioning container applying the humidity-conditioning sheet of the present invention. FIG. 11A shows the overall structure, and FIG. 11B shows the appearance of when the humidity-conditioning container is collapsed.

As shown in FIG. 1A, the humidity-conditioning container 700 uses a collapsible container 705 in the shape of a rectangular prism, and a humidity-conditioning sheet 715 is placed inside of the collapsible container 705. The collapsible container 705 comprises a frame body 701, side planes 710 and 711, collapsible side planes 712 and 714 (714 not shown), and a bottom 716.

The side planes 710 and 711 are individually attached to the bottom 716 with hinges, and have joints 710a and 711a, respectively (710a not shown). Normally, the side planes 710 and 711 stand vertically with the joints 710a and 711a inset with joints (tabs) 702 and 703 (703 not shown), respectively, which are provided on the frame body 701. The joints 702, 703, 710a and 711a may be projections each formed in a hook shape, or may instead be hook and loop fasteners. When the container is collapsed, the side planes 710 and 711 are folded inside the container, as shown in FIG. 11B, by using the joint 702.

On the collapsible side planes 712 and 714, hinges 713a, 713b, 714a, and 714b (714a and 714b not shown) are placed in the midsections along the longitudinal direction of the planes 712 and 714. When the container is collapsed, as shown in FIG. 11B, the collapsible side planes 712 and 714 are folded to the inside of the container by folding the hinges 713a, 713b, 714a, and 714b from outside in a manner that arms of each hinge close inward.

The frame body 701 that is formed in a rectangular shape is inset with a lid 720 and the inside of the container is thereby sealed.

Note that, although a configuration of the collapsible container is exemplified here, an uncollapsible (i.e. fixed shape) container can be used, instead.

The humidity-conditioning container 700 having such a configuration can be used for a delivery means to store perishable foods, for example. That is, high freshness of perishable foods can be preserved by setting the humidity-conditioning sheet 715 in a water absorption state in advance and thereby maintaining the inside of the container in a moisturized condition. Then, when the container is folded after being used, the humidity-conditioning sheet 715 is taken out. The humidity-conditioning sheet 715 can be made reusable by restoring it to the original dry state through a drying or a NaCl-solution treatment in the case when the humidity conditioner is composed of the PA/PVA, or through a heat treatment in the case when the humidity conditioner is composed of the PA/P-NIPAM.

On the other hand, by setting the humidity-conditioning sheet 715 in a dry state, it is possible to adequately preserve products sensitive to humidity such as magnetic tapes, semiconductor products, and processed foods like rice crackers.

### 7. Seventh Embodiment

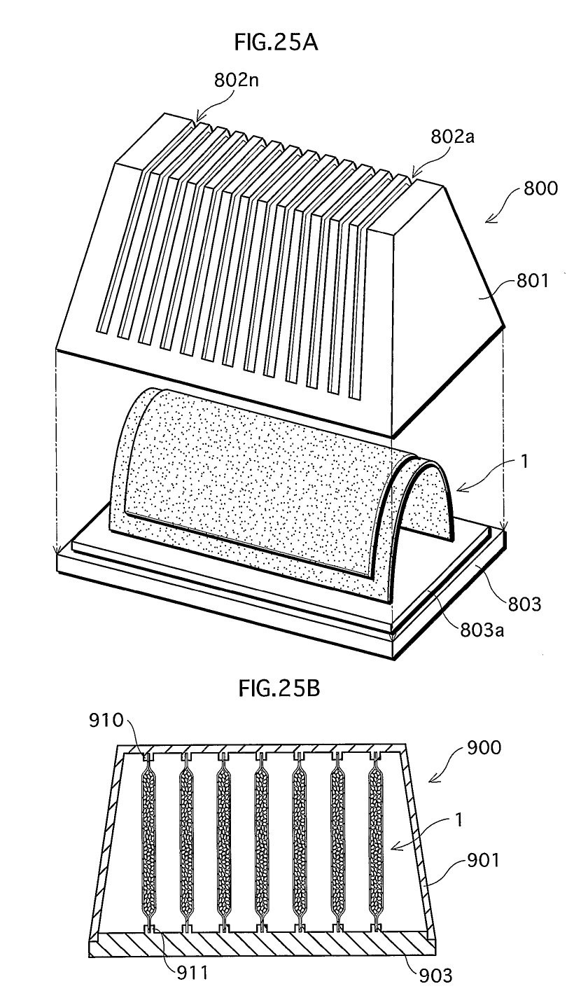

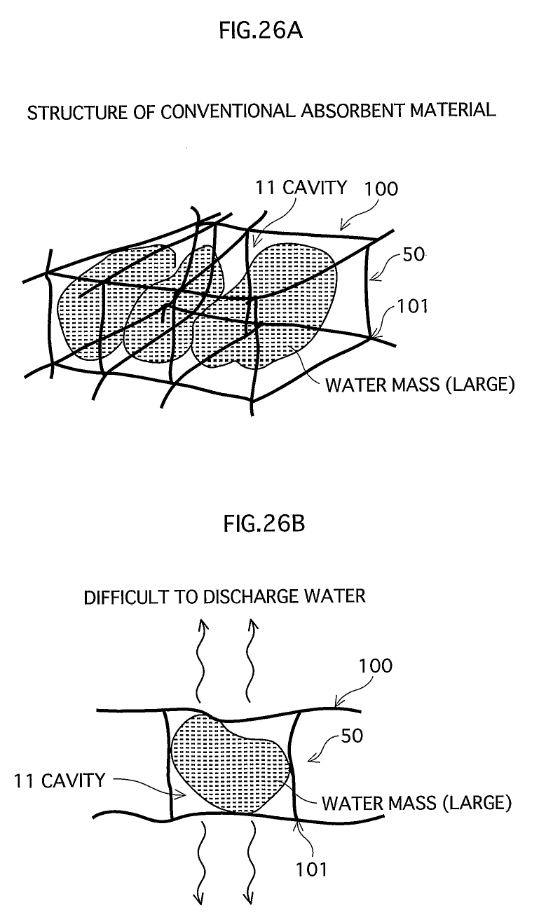

FIG. 25 shows a configuration of a case containing a humidity-conditioning sheet according to a seventh embodiment of the present invention.

A humidity-conditioning-sheet containing case 800 shown in FIG. 25A has a configuration where the humidity-conditioning sheet 1 of the first embodiment is stored between a pyramid-shaped, plastic housing 801 and a bottom cap 803.

Provided with the housing 801 are strip-shaped slits 802a to 802n communicated with the inside of the housing 801. Note that the shapes of the housing and slits are not limited to these.

On the upper surface of the bottom cap 803, a terraced portion 803a is formed and can be inset with the housing 801.

Here, the humidity-conditioning sheet 1 is stored inside of the housing 801 with being gently curved along the width direction. However, it may be stored with its main plane standing upright.

The humidity-conditioning-sheet containing case 800 having such a configuration allows a large area of the humidity-conditioning sheet 1 to be effective for conditioning humidity, and therefore an increased effect of humidity conditioning can be achieved. This is because both sides (i.e. main planes) of the humidity-conditioning sheet 1 are entirely exposed to the open air flowing through the inside of the housing 801 from the slits 802a to 802n during use. That is, the open air is effectively moisturized by setting the humidity-conditioning sheet 1 in a water retention state in advance. On the other hand, it is also possible to quickly absorb moisture from the open air by setting the humidity-conditioning sheet 1 in a dry state in advance.

The humidity-conditioning-sheet containing case 800 having such effects can be stored in a home or commercial refrigerator, for example, in order to condition the humidity of the inside of the refrigerator. Herewith, in the case of preserving perishable foods, such foods can be preserved well in an adequately moisturized condition by setting the humidity-conditioning sheet 1 in a water retention state. On the other hand, in the case of preserving water-sensitive processed foods, the foods can be stored away from moisture by setting the humidity-conditioning sheet 1 in a dry state.

Furthermore, the seventh embodiment is capable of fine-tuning the degree of humidity conditioning (or the humidity conditioning speed) with ease by adjusting the number of the humidity-conditioning-sheet containing cases 800 installed in a refrigerator.

By providing multiple humidity-conditioning sheets with the inside of the housing, it is possible to achieve further effective humidity conditioning while saving space. A humidity-conditioning-sheet containing case 900 shown in FIG. 25B has a configuration in which grippers 910 and 911 are provided in the interior of a housing 901 and on the surface of a bottom cap 903, respectively, so that multiple humidity-conditioning sheets 1 are set, being held firmly in the vertical position. On the housing 901, slits similar to the slits 802a to 802n are provided. Thus, the seventh embodiment is capable of realizing an increased effect of humidity conditioning while saving space by applying such creative designs to the configuration.

### 8. Related Matters

Other than the embodiments described above, the humidity conditioner of the present invention can be applied as a reinforcement filling resin material for wooden building materials. More specifically speaking, perforations are provided from the surface to the inside of building materials, and a resin material containing the humidity conditioner of the present invention is filled in the perforations. Herewith, it is possible to achieve the humidity conditioning effect while improving the strength of the building materials.

### INDUSTRIAL APPLICABILITY

The humidity conditioner of the present invention can be used as a humidity-conditioning sheet for assisting a long-term storage of, for example, perishable foods and magnetic tapes. Besides, the humidity conditioner is applicable to nursery pots, building materials, clothing, and the like.

1-12. (canceled)

13. A humidity conditioner having a configuration in which one or more water-soluble polymers are introduced into a three-dimensional framework that is formed by one or more crosslinked water-absorbing polymers, wherein
the water-absorbing polymers include either polyacrylate salt or one or more polyacrylate salt-polyvinyl alcohol copolymers, and
the water-soluble polymers are composed of one or both of polyvinyl alcohol and polyisopropylacrylamide.

14. The humidity conditioner of claim 13, wherein
the polyvinyl alcohol has a molecular weight in a range of no less than 500 but no more than 20000,
the polyisopropylacrylamide has a molecular weight in a range of no less than 1000 but no more than 30000, and
an amount of the water-soluble polymers introduced into the water-absorbing polymers is in a range of no less than 1% of a total mass of the humidity conditioner but no more than 30% of the total mass.

15. The humidity conditioner of claim 13, wherein
the water-absorbing polymers have a crosslinking ratio in a range of no less than 0.5% but no more than 5%.

16. A humidity-conditioning sheet having a configuration in which the humidity conditioner of claim 13 is encased with one or more water-permeable sheet members.

17. The humidity conditioner of claim 13, wherein
the polyvinyl alcohol is partially saponified, with no less than 900 and no more than 1100 monomer units being saponified.

18. The humidity conditioner of claim 13, wherein
the polyvinyl alcohol (i) has an average degree of polymerization of 1000 and is partially saponified with no less than 900 and no more than 1100 monomer units being saponified, or (ii) has an average degree of polymerization of 500.

19. The humidity conditioner of claim 13 to be set in one selected from the group consisting of clothing, hats, and helmets.

20. The humidity conditioner of claim 19, wherein
the clothing is a fatigue jacket, and
the humidity conditioner is a humidity-conditioning sheet encased with one or more water-permeable sheet members, and is to be set in the fatigue jacket with a hook and loop fastener in a detachable manner.

21. The humidity conditioner of claim 13 to be set in a building material.

22. The humidity conditioner of claim 21, wherein
the building material is a humidity-conditioning glass in which a humidity-conditioning layer having the water-soluble polymers encased with a water-permeable resin film is set on a surface of a glass, the water-soluble polymers being composed of the polyisopropylacrylamide.

23. The humidity conditioner of claim 21, wherein
the building material is a humidity-conditioning tatami mat in which a humidity-conditioning sheet having the humidity conditioner encased with one or more water-permeable sheet members is set between a mat surface and an inside padding.

24. The humidity conditioner of claim 21, wherein
the building material is a wooden building material inside of which the humidity conditioner is filled.

25. A humidity conditioning method using a humidity conditioner that has a configuration in which polyvinyl alcohol is introduced into a three-dimensional framework composed of one or more water-absorbing polymers, comprising the following steps:
having the humidity conditioner absorb water; and
adjusting a water discharge with an osmotic pressure gradient established by adding a sodium chloride solution having a concentration of no less than 0.01 M but no more than 3 M to the water-absorbed humidity conditioner.

26. The humidity conditioning method of claim 25, wherein
the sodium chloride solution is added so that a weight ratio of sodium chloride to the introduced polyvinyl alcohol is substantially 1:1.

27. The humidity conditioning method of claim 25, wherein
the water-absorbing polymers are composed of either sodium polyacrylate or one or more sodium polyacrylate-polyvinyl alcohol copolymers.

28. A humidity conditioning method using a humidity conditioner that has a configuration in which one or more water-soluble polymers composed of polyvinyl alcohol are introduced into a three-dimensional framework composed of one or more water-absorbing polymers, comprising the following steps:
having the humidity conditioner absorb water; and
adjusting a water discharge by causing the water-soluble polymers to swell with the water entered into the framework to thereby discharge the absorbed water to an outside of the framework.

29. The humidity conditioning method of claim 28, wherein
the water-absorbing polymers are composed of either sodium polyacrylate or one or more sodium polyacrylate-polyvinyl alcohol copolymers.
